(19) United States
(12) Patent Application Publication
(10) Pub. No.: US 2025/0327773 A1
(43) Pub. Date: Oct. 23, 2025

(54) MEASURING SYSTEM FOR MEASURING AN ION CONCENTRATION IN A PROCESS LIQUID USING CAPILLARY ELECTROPHORESIS AND METHOD THEREFOR

(71) Applicant: CE-LINE B.V., Emmeloord (NL)

(72) Inventors: Maarten JORNA, Emmeloord (NL); Tim DE JONG, Emmeloord (NL); IJnse HAITSMA, Emmeloord (NL)

(73) Assignee: CE-LINE B.V., Emmeloord (NL)

(21) Appl. No.: 18/868,396

(22) PCT Filed: May 24, 2023
(86) PCT No.: PCT/NL2023/050299

§ 371 Date: Nov. 22, 2024

(30) Foreign Application Priority Data
May 24, 2022 (NL) 2031969

(51) Int. Cl. G01N 27/447

(52) U.S. Cl. CPC G01N 27/44743; G01N 27/44756

(57) ABSTRACT

A measuring system for measuring an ion concentration in a process liquid using capillary electrophoresis. The system includes a feeding line extending between a first and a second end, wherein the feeding line has a flow direction from the first to the second end, an inlet connected to the feeding line at the first end, a pump in the feeding line, an expansion vessel connected to the feeding line with an expansion line, where the expansion line is provided with a first valve, and a capillary electrophoresis measuring device that is connected to the feeding line at the second end. The pump, the first valve and the expansion vessel cooperate to build up and release pressure for loading samples in the capillary electrophoresis measuring device.

The present invention relates to a measuring system for measuring an ion concentration in a process liquid using capillary electrophoresis. The present invention further relates to a method for measuring an ion concentration in a process liquid using capillary electrophoresis. Such process liquids relate to, among others, water treatment, drinking-water production, (glass) horticulture, fermentation, food processing, pharmaceutical processing and industrial process flows. The ion concentration can comprise inorganic as well as organic ions.

Capillary electrophoresis, also referred to as CE, is an analytical separation technique. Use is made in capillary electrophoresis of an electric field that is applied over a capillary such that a sample that is loaded onto the capillary flows through the capillary and will be separated. This separation is caused by the differences in the electrophoretic mobility of particles from the sample. Among other factors, the charge and the dimensions of the particle all may influence the difference in electrophoretic mobility of the particles.

Measuring systems are known which make use of capillary electrophoresis. The known measuring systems change the capillary from a buffer liquid container to a sample liquid container to load the sample liquid. This requires a pressure, for example of 2 bar, to fill the capillary with a processing fluid. In order to fill the capillary with the processing liquid, also the vessels wherein the processing liquid is provided are brought under pressure for filling the capillary.

A disadvantage of the known measuring systems is that the walls of the vessel containing the processing liquid need to be relatively thick in order to withstand the pressure. As a result, the vessels are expensive. A further disadvantage is that the filling of the capillary with a processing liquid is not sufficiently repeatable, as the pressure obtained with applying the pressure to the vessels containing the processing liquid can vary.

It is an object for the present invention to obviate or at least reduce the abovementioned problems. In particular, it is an object of the present invention to provide a measuring system that obtains a repeatable amount of the processing liquid filled in the capillary.

This object is achieved by a measuring system for measuring an ion concentration in a process liquid using capillary electrophoresis, wherein the measuring system comprises:
a feeding line extending between a first and a second end, wherein the feeding line has a flow direction from the first to the second end:
an inlet that is connected to the feeding line at the first end:
a pump provided in the feeding line:
an expansion vessel that is connected to the feeding line with an expansion line,
wherein the expansion line is provided with a first valve; and
a capillary electrophoresis measuring device that is connected to the feeding line at the second end,
wherein the pump, the first valve and the expansion vessel cooperate to build up and release pressure for loading samples in the capillary electrophoresis measuring device.

Due to the pump, the first valve and the expansion vessel cooperating to build up and release pressure, a stand-alone system for injecting samples in the capillary electrophoresis measuring device in an automated way is obtained. An advantage hereof is that the sample can be effectively loaded in the capillary electrophoresis measuring device. For example, the pump can be controlled by a controller to automatically inject the samples in the capillary. This has the advantage that the sample solution can be provided to the capillary automatically. It is clear that also other solutions, such as buffer solutions, can in this way be automatically injected in the capillary electrophoresis measuring device.

A further advantage of the present invention is that all elements being provided before the inlet can be maintained in atmospheric pressure. This has the advantage that the sample solution and buffer solution container (or vessel) which can be connected to the inlet does not need to withstand a higher than atmospheric pressure and thus can be relatively cheap. The high pressure is built up in the measuring system itself, mainly the feeding line.

Due to the expansion vessel, an effective built up of the same amount of pressure can be obtained. The pump is configured to pump processing liquid into the expansion vessel when the first valve is open, thereby increasing the pressure of the processing liquid in the expansion vessel. Furthermore, the expansion vessel can provide an effective release of the pressurized processing liquid through which sample solution or buffer solution can effectively be transported through the measuring system. An additional advantage of the present configuration with an expansion vessel is that the measuring system as a whole can be substantially small. This reduces the amount of storage-space and reagents needed for the measuring system and thus reduces its cost during use.

It is noted that the expansion vessel in the context of the present invention should be understood as a device that is configured to achieve a build-up of pressure. For example, a feeding line comprising an inner throughput line and an outer tube coaxially provided over the feeding line, wherein the space between the feeding line and outer tube is configured to receive pressurized air such that the feeding line is closed off in order to build up pressure during running of the pump, can also be understood as being an expansion vessel. Running the pump can also be understood as operating the pump or activating the pump, meaning that the pump is in an active state of pumping.

Next to this, the switching and/or replacement of sample solution that is measured is simplified. Alternatively or additionally, the maintenance of the measuring system is also easy.

The processing liquid can be, amongst others, a sample liquid, a buffer liquid or a cleaning liquid. In the context of the present invention, reagents may denote buffer liquids, cleaning liquids and calibration liquids. The buffer liquid may be an anion buffer liquid or a cation buffer liquid. The feeding line can for example be embodied as a tube, channel or pipe or any other element that is suitable for the throughput of liquid. The capillary electrophoresis measuring device preferably comprises at least one capillary. The cleaning liquid may be a base, such as sodium hydroxide (NaOH) solution or an acid such as hydrochloric acid (HCl), or ultrapure water.

In an embodiment according to the invention the feeding line comprising a second valve positioned between the pump and the second end of the feeding line.

Due to the second valve the pressure which can be built up in the expansion vessel can selectively be released to the the capillary electrophoresis measuring device. In practice, the second valve can be closed during the build-up of the pressure and be opened after pressure is build-up to release the pressurized processing liquid into the capillary electrophoresis measuring device. By opening the second valve for a controlled time, preferably a predetermined time period, the sample and other processing liquids can be controlled in a repeatable way.

In an embodiment according to the invention the capillary electrophoresis measuring device comprises a first and second capillary, the first being an anion capillary and the second being a cation capillary.

An advantage of the first and second capillary is that both the anion ions and cation ions can be effectively measured in the sampling liquid. This increases the usability of the measuring system according to the invention.

In an embodiment according to the invention the capillary electrophoresis measuring device is connected to a three-way valve that connects the second end of the feeding line with the first capillary and the second capillary, the first and second capillary both preferably being in contact with an associated buffer solution waste container.

The three-way valve comprises three passageways, wherein a first passageway is operatively connected to the feeding line, a second passageway is operatively connected to the first capillary and the third passageway is connected to the second capillary. Due to the three-way valve the processing liquid can effectively be transported from the feeding line to the first and second capillary.

In an embodiment according to the invention the three-way valve and the first and second capillary are connected with a respective T-piece.

Due to the T-piece the pressurized processing liquid can effectively be inserted into the capillary electrophoresis measuring device.

Alternatively, the first and second capillary are connected to each other in order to form a singular capillary, and the sample solution is inserted in the middle of the singular capillary.

In an embodiment according to the invention the measuring system further comprises a waste container that is operatively connected to the expansion vessel, the feeding line and/or the capillary electrophoresis measuring device.

An advantage of the waste container is that processing liquid can effectively be collected into the waste container. Due to the expansion vessel, the feeding line and or the capillary electrophoresis measuring device being operatively connected to the waste container, processing fluid can be throughput from each of these elements to the waste container.

In an embodiment according to the invention each of the expansion vessel, the feeding line and the capillary electrophoresis measuring device are operatively connected to the waste container with a respective line, each line being provided with a valve.

In the context of the present invention, the valve from expansion vessel to the waste container is denoted as the third valve, the valve from the feeding line, between the second valve and the capillary electrophoresis measuring device, to the waste container is denoted as the fourth valve, and the valve from the capillary electrophoresis measuring device to the waste container is denoted as the fifth valve.

Due to the third, fourth and fifth valve the processing liquid can selectively be allowed to flow towards the waste container.

In an embodiment according to the invention the system further comprises a pressure sensor that is connected to the expansion vessel.

An advantage of the pressure sensor is that the pressure in the processing liquid can be easily read and controlled. The pump can be configured to stop running when a predetermined pressure is reached. After reaching this predetermined pressure the second valve can be opened for a predetermined time period. This achieves that the amount of processing liquid, and there with the amount of processing liquid which is inserted into the capillary electrophoresis measuring device, is effectively controllable. This ensures that a reliable measurement is achieved. Preferably, the pressure sensor comprises a manometer.

In an embodiment according to the invention the capillary electrophoresis measuring device comprises voltage circuit that is provided over a capillary.

Due to the voltage circuit a voltage can be put over the capillary which separates the ions in the sample liquid based on their electrophoretic mobility.

In an embodiment according to the invention the capillary electrophoresis measuring device comprises a contactless conductivity detector.

The contactless conductivity sensor can effectively detect conductivity of the sampling liquid, and thus detect the ions which move through the capillary. Alternatively, or additionally, the capillary electrophoresis measuring device comprises other detectors, such as an ultraviolet sensor or a mass spectrometry detector.

In an embodiment according to the invention the inlet comprises a multivalve.

An advantage of the multivalve is that multiple containers or vessel can be connected to the multivalve. For example, the multivalve can be connected to the anion buffer liquid, the cation buffer liquid, and the sample liquid. In this way, the multivalve can provide for all the necessary liquids to obtain the capillary electrophoresis measurement.

In an embodiment according to the invention the multivalve is connected to a second buffer solution container and a sample solution inlet such that the buffer solution and the sample solution are feedable into the feeding line.

The second buffer solution may be an anion buffer solution or a cation buffer solution. In an embodiment the multivalve is connected to both an anion buffer solution container and a cation buffer solution container. Due to the multivalve being connected to the second buffer solution container and the sample solution inlet the buffer solution and sample can be inserted into the measuring system to rinse the system or to fill the capillary electrophoresis measurement device with the buffer solution or sample solution.

In an embodiment according to the invention the measuring system further comprises a loading module comprising a buffer solution and/or a cleaning solution that is operatively connected to the inlet.

Due to the loading module the necessary liquids for executing a capillary electrophoresis measurement are provided by the connection of the loading module to the inlet. In this way, it is also possible for persons that have no experience in doing capillary electrophoresis measurements to easily exchange the processing liquids. Additionally, the loading module can be easily disconnected in order to connect a further loading module, for example when the container wherein the buffer solution and cleaning solution are provided are empty.

Alternatively or additionally, the loading module comprises a calibration solution. The calibration solution is a known solution comprising a predetermined concentration of ions. The calibration solution can be loaded as a sample onto the capillary electrophoresis measurement device in order to calibrate the sensors of the measurement device or to indicate that the sensor is working correctly.

In an embodiment the measuring system comprises a dilution controller that is operatively connected to and configured to control at least one of the inlet, the pump, the first valve, the second valve, the third valve, the fourth valve and/or the fifth valve. The controller may be configured to connect the inlet to a specific processing liquid. The controller may set the pump to run or turn the pump off. The controller may set to close or open the valves.

Alternatively, or additionally, the controller may be configured to dynamically dilute the sample solution, preferably diluting the sample solution with ultrapure water. In this embodiment, the measuring system further preferably comprises an ultrapure water container that is connected with the multivalve. Optionally, the measuring system comprises a mixing device that is configured to mix the sample solution with the ultrapure water in order to dilute the sample solution. The amount of dilution can be predetermined. Alternatively, in an embodiment enabling dynamically diluting the sample solution, the amount of dilution may be determined by the preceding measurements of the sample solution, thereby achieving a dynamic dilution of the sample solution. This ensures a successful measurement of the sample solution. For example, the dilution controller may determine during a measurement that the peaks of ion concentration that are measured are higher than a predetermined value, thereby determining that the ion concentration is too high. The dilution controller may then set the mixing device to increase the amount of dilution in order to bring the peaks of the ion concentration below the predetermined value. This is an example of dynamically diluting the sample solution. In another example, in case the detection is relatively sensitive, low quantities of ions can be measured. When higher concentrations are available, the sample needs to be diluted towards measurable quantities. To enable handling of such situation, in one of the presently preferred embodiments, the measuring system contains a.

preferably automated, dilution set-up, which will dilute the sample dynamically (adaptively). In such embodiment, the first input is the sample source and the expected concentrations (or total conductivity). This is predetermined input, which ensures predetermined boundaries. The second input is a built-in conductivity sensor. This gives additional information about the total sample and its dilution level. The dilution controller determines if the expected concentration(s) and the set boundaries from the first input match. If so, the dilution factor remains the same. If not, the dilution factor is changed. The third input is the actual measurement(s). If peaks in the electropherogram exceeds the maximum set values, the dilution controller calculates the new dilution which will be suitable for effective measurements with the measurement system. The dilution controller can be a separate controller or can be integrated in the controller of the measurement system. The dilution is optionally performed in a dilution unit that preferably comprises a mixing tank and a mixing device.

In an embodiment the measuring system comprises a temperature regulating device that is configured to regulate the temperature of the measuring system as a whole. The temperature regulating device may comprise insulation material and/or an (air) cooling system.

The present invention further relates to a water measuring system, such as a horticulture water measuring system, comprising:
a measuring system according to any one of the foregoing embodiments: and
a water system that is operatively connected to the inlet for providing a sample solution.

The water measuring system has similar effects and advantages as described for the measuring system. In particular, the water measuring system gives the possibility to continuously and automatically monitor the water system, for example of horticulture water measuring system. This is especially advantageous as the ions levels in the water change substantially during the day and/or week due to the influence of weather conditions, for example the amount of sunshine. Therefore, it is advantageous to be able to measure the ion levels in the water of the horticulture water system continuously. The skilled person understands that continuously in the present invention denotes unbroken measurements as well as taking measurements at regular intervals, the intervals being relatively small such as every 5 minutes or every half hour.

The present invention further relates to a method for measuring an ion concentration in a process liquid using capillary electrophoresis, comprising:
filling a feeding line and a capillary electrophoresis measuring device with a buffer solution by using an expansion vessel:
filling the feeding line and the capillary electrophoresis measuring device with a sample solution by using the expansion vessel: and
applying a high voltage over the capillary to measure the sample solution with a detector of the capillary electrophoresis measuring device.

The method has similar effects and advantages as described for the measuring system and the water measuring system. Preferably, the method comprises the step of providing a measuring system according to any one of the above-described embodiments of the invention.

In an embodiment according to the invention filling the feeding line and the capillary electrophoresis measuring device with the buffer solution comprises:
filling the feeding line with the buffer solution by providing the buffer solution through an inlet at a first end of the feeding line and opening a second valve positioned on the feeding line towards a capillary electrophoresis measuring device that is positioned at a second end of the feeding line:
building pressure on the buffer solution in the feeding line by running a pump positioned on the feeding line between the inlet and the second valve and opening a first valve to the expansion vessel and closing the second valve: and
releasing the pressurized buffer solution towards the capillary electrophoresis measuring device by opening the second valve in order to fill the capillary with the buffer solution.

Due to building pressure on the buffer solution the buffer solution can effectively be loaded in the capillary electrophoresis measuring device.

In an embodiment according to the invention filling the feeding line and the capillary electrophoresis measuring device with the sample solution comprises:
filling the feeding line with the sample solution by providing the sample solution through the inlet and opening the second valve:
building pressure on the sample solution in the feeding line by running the pump and opening the first valve to the expansion vessel and closing the second valve: and
loading the sample solution in the capillary by releasing the pressurized sample solution towards the capillary electrophoresis measuring device by opening the second valve.

The second valve may be opened for a predetermined time period. Due to building pressure on the sample solution and the controlled opening time of the second valve, the sample solution can effectively be loaded in the capillary electrophoresis measuring device. Alternatively or additionally, the build-up of pressure with the expansion vessel ensures that a controllable and repeatable pressurized solution is achieved and thus that the same amount of sample liquid can be inserted in the capillary of the capillary electrophoresis measurement device. This is further improved by the volume of processing liquid or sample liquid that is created in the expansion vessel during build-up of pressure.

In an embodiment the sample solution is diluted before being provided into the inlet. The sample solution can be diluted by adding ultrapure water to the sample solution. The amount of dilution can be predetermined. Alternatively, the amount of dilution may be determined by the preceding measurements of the sample solution, thereby achieving a dynamic dilution of the sample solution. This ensures a successful measurement of the sample solution. For example, it may be determined that during a measurement the peaks of ion concentration that are measured are higher than a predetermined value, thereby determining that the ion concentration is too high. In response thereto the amount of dilution may be increased in order to bring the peaks of the ion concentration below the predetermined value. The dilution is preferably performed in a dilution unit as described in relation to one of the preferred embodiments of the measurement system.

In an embodiment according to the invention the method further comprises:
releasing the pressure in the system after filing the capillary electrophoresis measuring device with the sample solution by opening a third valve positioned between the expansion vessel and a waste container and fourth valve positioned between the feeding line and the waste container and closing the second valve.

In an embodiment according to the invention the method further comprises closing the third valve, the fourth valve and a fifth valve positioned between the capillary electrophoresis measuring device and the waste container during the step of building and releasing pressure on the buffer solution and during the step of building and releasing pressure on the sample solution.

In an embodiment according to the invention the step of filling the feeding line and the capillary electrophoresis measuring device with a sample solution is repeated before applying a high voltage over the capillary to measure the sample solution such that multiple sample solution units are loaded on the capillary electrophoresis measuring device.

In the context of the present invention a sample solution unit is an amount of sample solution loaded onto the capillary electrophoresis measuring device during one step of filling the feeding line with the sample solution, building pressure on the sample solution in the feeding line, and loading the sample solution in the capillary.

Due to the loading of multiple sample solution units the number of measurements can be reduced, thus decreasing costs.

In an embodiment according to the invention the method further comprises:
filling the feeding line with the buffer solution by providing buffer solution through the inlet after loading the solution in the capillary.

It is clear for the skilled person that the structural features described for the measuring system and the water measuring system can be applied to the method and that the method steps described for the method can be applied on the measuring system and water measuring system.

Further advantages, features and details are elucidated on the basis of preferred embodiments thereof, wherein reference is made to the accompanying drawings, wherein:

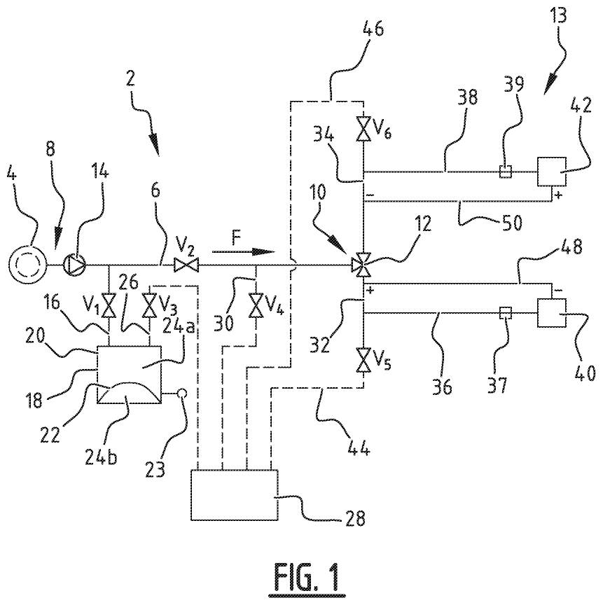

FIG. 1, shows an example of a measurement system according to the invention:

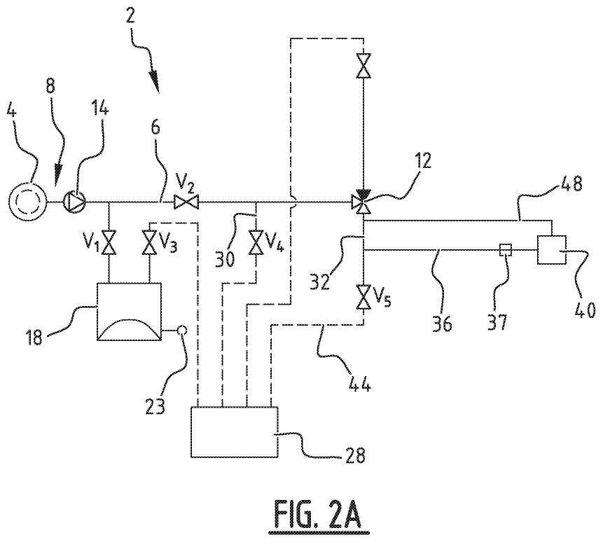

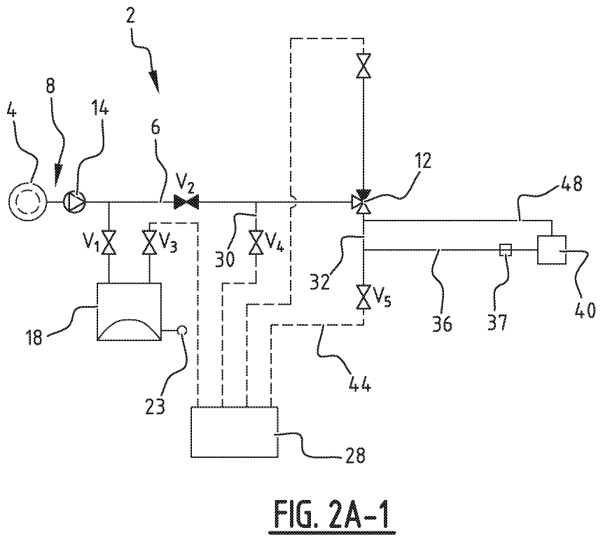

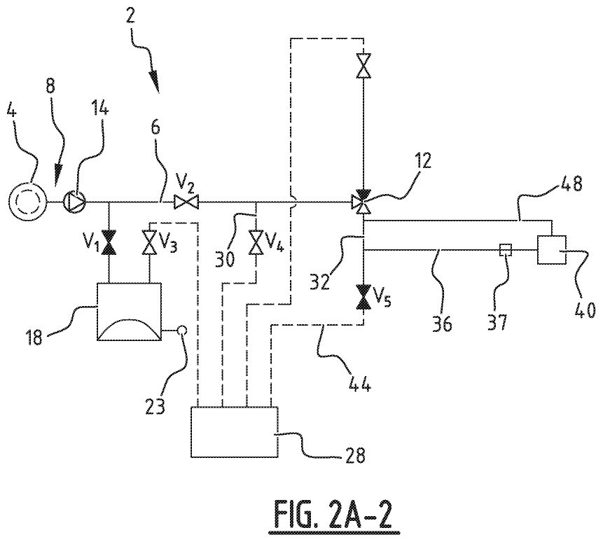

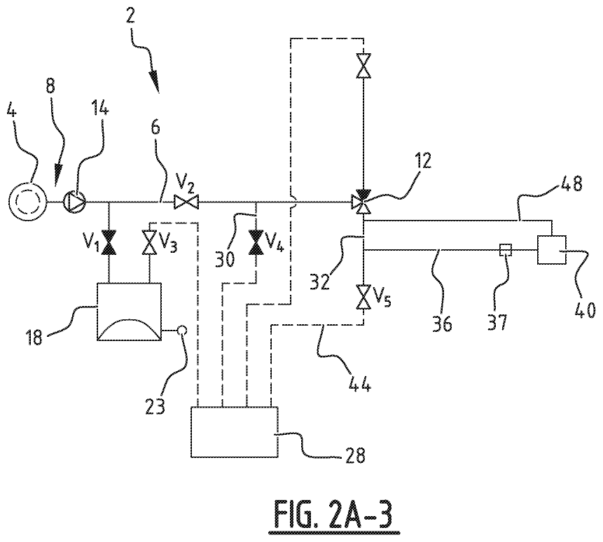

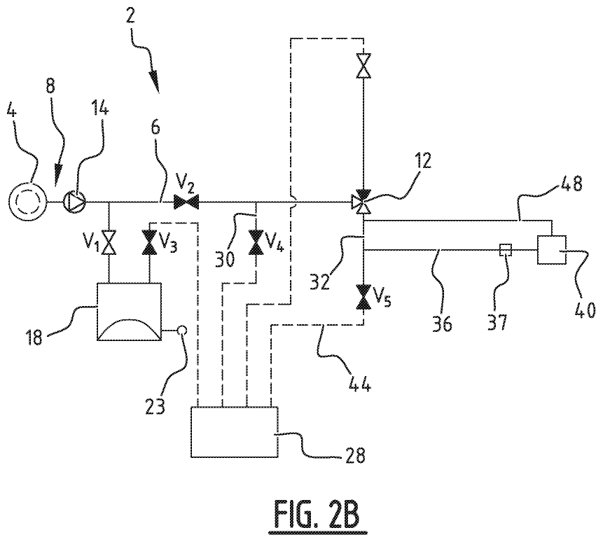

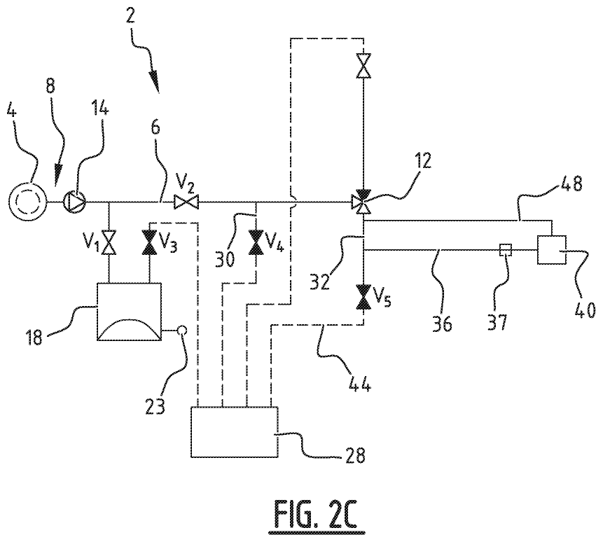

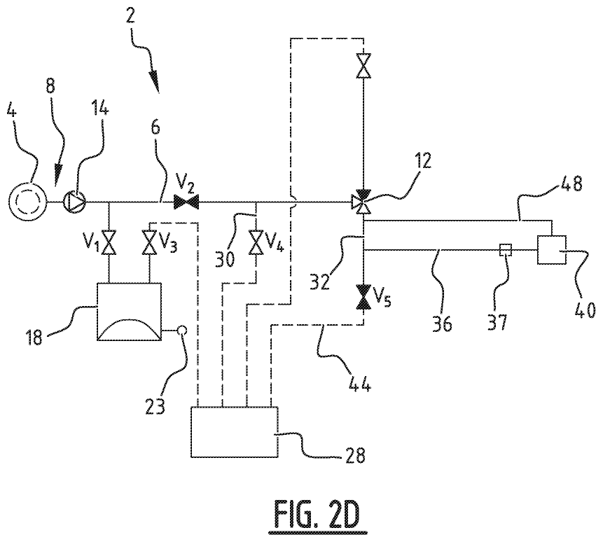

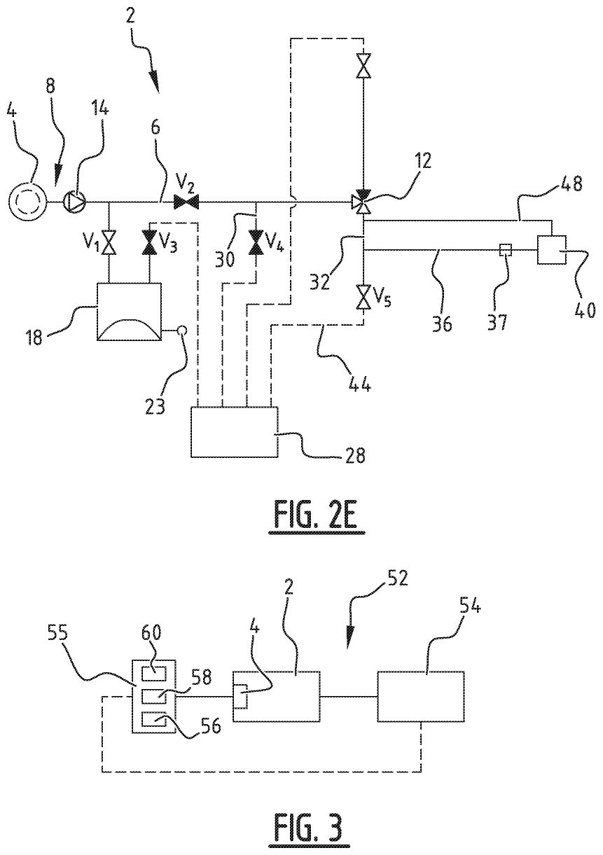

FIGS. 2A-E, shows steps of doing measurements with the measurement system according to the invention: and

FIG. 3, shows an example of a water measurement system according to the invention.

Measurement system 2 (FIG. 1) comprises inlet 4, which in the illustrated embodiment comprises a multivalve. Inlet 4 is connected to first end 8 of feeding line 6. Feeding line 6 extends between first end 8 and second end 10, wherein second end 10 is connected to three-way valve 12. Flow direction F is from first end 8 to second end 10 of feeding line. Positioned on feeding line 6 is pump 14. Further attached to feeding line 6, downstream from pump 14, is expansion line 16. Expansion line 16 extends from feeding line 6 to expansion vessel 18 and is provided with first valve V₁. Expansion vessel 18 comprises housing 20 wherein membrane 22 is provided that defines inner space 24a and gas space 24b in housing 20. Inner space 24a is in fluid contact with expansion line 16 and gas space 24b comprises air. Further operatively connected to inner space 24a is expansion vessel waste line 26 whereon third valve V₃ is provided. Expansion vessel waste line extends towards waste container 28. Expansion vessel 18 is further provided with pressure sensor 23, in the illustrated embodiment a manometer.

Feeding line 6 further comprises second valve V₂ that is positioned downstream expansion line 16. Operatively connected to feeding line 6 is feeding waste line 30 which is provided with fourth valve V₄ and extends towards waste container 28.

Connected to three-way-valve is measurement device 13. Measurement device 13 comprises first T-piece 32, second T-piece 34, cation capillary 36, anion capillary 38, buffer cation vessel 40, buffer anion vessel 42 and high voltage circuit 48 and 50. Three-way valve 12 is operatively connected to first T-piece 32 and second T-piece 34. The leg of first T-piece 32 is cation capillary 36 and the leg of second T-piece 34 is anion capillary 38. Cation capillary 36 extends towards buffer cation vessel 40 and anion capillary 38 extends towards buffer anion vessel 42. First T-piece 32 comprises fifth valve V₅ at opposite end of three-way-valve 12 on the crossmember and second T-piece 34 comprises sixth valve V₆ at opposite end of three-way-valve 12 on the crossmember. Both fifth valve V₅ and sixth valve V₆ are respectively positioned on measurement device waste line 44 and 46 extending towards waste container 28. First high voltage circuit 48 is connected from buffer cation vessel 40 to first T-piece 32 and second high voltage circuit 50 is connected from buffer anion vessel 42 to second T-piece 34. In this illustrated embodiment first capillary 36 is provided with first contactless conductivity sensor 37 and second capillary 38 is provided with second contactless conductivity sensor 39. It is clear for the skilled person that other detectors or sensors, such as ultraviolets sensors, are also possible.

Valves which are closed are depicted as being coloured, while valves which are open are depicted as outlined.

Measuring system 2 (FIG. 2A) is configured to fill in a first step feeding line 6 with a buffer cation solution by providing the buffer solution through inlet 4 at first end 8 of feeding line 6. In the first step second valve V₂ is opened. In this first step inlet 4 may be connected to a buffer cation vessel. In the first step first valve V₁, second valve V₂, third valve V₃, fourth valve V₄ and fifth valve V₅ are open. Three-way valve 12 is closed towards second T-piece 34 and opened towards first T-piece 32. As subsequently only a measurement with first capillary 36 is described, three-way valve 12 stays closed towards second T-piece 34. Pump 14 is running to fill measuring system 2 with buffer solution up to first capillary 36.

Alternatively or additionally, the first step may be divided into sub steps. For example, in a first sub step (FIG. 2A-1) of the first step the second valve V₂ is closed, while first valve V₁, third valve V₃, fourth valve V₄ and fifth valve V₅ are open. In the first sub step way expansion vessel 18 is filled with buffer cation solution. In a second sub step (FIG. 2A-2) of the first step first valve V₁ and fifth valve V₅ are closed, while second valve V₂, third valve V₃ and fourth valve V₄ are open. In the second sub step feeding line 6 and feeding waste line 30 are filled with buffer cation solution. In a third sub step (FIG. 2A-3) of the first step first valve V₁ and fourth valve V₄ are closed, while second valve V₂, third valve V₃ and fifth valve V₅ are open. In the third sub step T-piece 32 and measurement waste line 44 are filled with buffer cation solution.

In a second step (FIG. 2B) measuring system 2 is configured to build up pressure on the buffer solution in feeding line 6. In the second step second valve V₂, third valve V₃, fourth valve V₄ and fifth valve V₅ are closed. Then pump 14 is run to build up pressure in expansion vessel 18, as first valve V₁ is still open and valve V₃ is closed. Inlet 4 is still connected to a buffer cation solution vessel.

In a third step (FIG. 2C) measuring system 2 is configured to insert the buffer solution into first capillary 36 of measuring device 13. Second valve V₂ is opened, compared to the second step, to let buffer solution into first capillary 36. Pump 14 is stopped when pressure sensor 23 signals that the pressure is high enough for first capillary 36 being filled.

In a fourth step measuring system 2 is configured to fill feeding line 6 with a sample solution. The fourth step comprises the same configuration as depicted for the first step (FIG. 2A), with the difference that a sample solution vessel is connected to inlet 4. By running pump 14 measuring system 2 fills with sample solution up to first capillary 36.

In a fifth step, measuring system 2 is configured to build up pressure on the sample solution in feeding line 6. The fifth step comprises the same configuration as depicted for the second step (FIG. 2B), with the difference that a sample solution vessel is connected to inlet 4. Then pump 14 is run to build up pressure in expansion vessel 18, as first valve V₁ is open and third valve V₃ is closed.

In a sixth step measuring system 2 is configured to insert the sample solution into first capillary 36 of measuring device 13. The sixth step comprises the same configuration as depicted for the third step (FIG. 2C), with the difference that a sample solution vessel is connected to inlet 4. Second valve V₂ is opened shortly for a predetermined time period to let a predetermined amount of sample solution into first capillary 36. During the opening of second valve V₂ pump 14 is not running, thus the amount of sample solution inserted into capillary 36 is determined by the pressure that is built up the predetermined time period that valve V₂ opens.

In a seventh step (FIG. 2D) measuring system 2 is configured to release pressure in measuring system 2. In the seventh step second valve V₂ and fifth valve V₅ are closed while third valve V₃ and fourth valve V₄ are opened, such that pressurized process liquid can flow towards waste container 28.

In an eighth step measuring system 2 is configured to fill and/or rinse the measuring system 2 with buffer cation solution. The eighth step comprises the same configuration as depicted for the first step (FIG. 2A). Inlet 4 is connected to a buffer cation solution again. In the eighth step first valve V₁, second valve V₂, third valve V₃, fourth valve V₄ and fifth valve Vs are open. Pump 14 is then run to rinse the tubing of measuring system 2 with the buffer solution.

Alternatively or additionally, the eighth step may be divided into sub steps. For example, in a first sub step (FIG. 2A-1) of the eighth step the second valve V₂ is closed, while first valve V₁, third valve V₃, fourth valve V₄ and fifth valve V₅ are open. In the first sub step way expansion vessel 18 is filled with buffer cation solution. In a second sub step (FIG. 2A-2) of the eighth step first valve V₁ and fifth valve V₅ are closed, while second valve V₂, third valve V₃ and fourth valve V₄ are open. In the second sub step feeding line 6 and feeding waste line 30 are filled with buffer cation solution. In a third sub step (FIG. 2A-3) of the eighth step first valve V₁ and fourth valve V₄ are closed, while second valve V₂, third valve V₃ and fifth valve V₄ are open. In the third sub step T-piece 32 and measurement waste line 44 are filled and/or rinsed with buffer cation solution. In a ninth step (FIG. 2E) measuring system 2 is configured to do a measurement with contactless conductivity sensor 37 provided on first capillary 36. In the ninth step a high voltage is put over high voltage circuit 48, which moves the ions of the sample liquid from T-piece 32 towards buffer cation vessel 40. Contactless conductivity sensor 37 measures the ions in the sample liquid. In the ninth step second valve V₂, third valve V₃ and fourth valve V₄ are closed. This ensures that buffer solution stays at T-piece 32 for ensuring a correct measurement while the voltage is applied by high voltage circuit 48.

Water measurement system 52 (FIG. 3) comprises measuring system 2 that is connected to water system 54 of a greenhouse horticulture. Other water systems, for example of industrial or agricultural water processes are also possible to be connected to measuring system 2. Measuring system 2 can be connected to water system 54 either in-line or at-line. Additionally, or alternatively, loading module 55 is connected to inlet 4 of measurement system 2. Loading module 55 comprises cleaning solution vessel 56 and buffer solution vessel 58. Buffer solution vessel 58 may comprise a cation buffer solution or an anion buffer solution. Cleaning solution vessel 56 may comprise a base such as sodium hydroxide (NaOH) solution or an acid such as hydrochloric acid (HCl). Cleaning solution vessel 56 may further comprise ultrapure water for rinsing measuring system 2. Loading module 55 may further comprise calibration solution vessel 60 comprising a calibration cation solution and/or a calibration anion solution. Loading module 55 can be easily coupled and uncoupled to inlet 4 in order to provide measuring system 2 with reagents in an easy way. In an embodiment, water system 54 is operatively connected to cleaning solution vessel 56. In an alternative embodiment, loading module 55 only comprises buffer solution vessel 58 to provide buffer solution to measuring system 2.

Periodically, the calibration solution, which can also be denoted as standard solution, is inserted into capillary 36 and capillary 38 in the same way as buffer solution and sample solution is inserted capillary 36 and capillary 38. This calibration solution is measured. The concentration of ions in the calibration solution are known and can thus serve as a calibration for the samples. The peaks of the calibration solution that is measured via sensors 37 and 39 can be compared to the peaks of a measurement of the sample solution. This comparison can determine the concentration of the ions in the sample solution.

In case the deviation of the peaks of the calibration solution are higher than a predetermined peak of concentration of ions, system 52 will automatically start cleaning with the cleaning solution. After cleaning system 52 calibration solution can again be inserted into capillary 36 and capillary 38 to measure and compare with the predetermined peak of concentration of ions. If the measured peaks are in a predetermined bandwidth, system 52 can continue measuring sample solution. In case the measured peaks are not in the predetermined bandwidth, system 52 may signal an operator to execute maintenance, for example via a controller.

In one of the presently preferred embodiments measuring system 2 is confronted with samples having varying concentrations. In such embodiments measuring system 2 is provided with or alternatively connected to a dilution system. In such cases, additional information of the sample source can be known, for example conductivity or estimated concentrations. This information is (manually) provided to a dilution controller as a first input. The dilution controller can be a separate controller or can be integrated in the controller of measuring system 2. A conductivity sensor, or any other suitable sensor, provides the conductivity as an input parameter where the dilution can be based on as a second input. The dilution controller collects all data and calculates the needed dilution factor. This factor is then preferably used by a dilution system with actions for the multivalve, flow and time, and optional mixing device to ensure the actual dilution is made. The dilution system dilutes the sample with ultra-pure water in a mixing tank, for example. Preferably, the sample is diluted, and a measurement is performed. Peaks are detected with sensors 37 and/or 39, and the area of these peaks is calculated to identify specific ions. To obviate a problem with too high peaks, the sample requires a higher dilution factor. This information is the input for the dilution control. After measurement the used (and unused) liquids are discharged. Optionally, an external system may provide information about the first and/or second inputs to the dilution controller.

In further preferred embodiments, measurement system 2 comprises other detectors and/or is operatively connected thereto. Such other detectors may include one or more of Capacitively-Coupled Contactless Conductivity Detectors (C4D), Ultraviolet-Visible Spectroscopy Detection (UV/VIS), Single Wavelength Detector (SWD), Mass Spectrometer (MS), Fluorescence Detector (FLD), Variable Wavelength Detector (VWD), Diode Array Detector (DAD) also known as

Photodiode Array (PDA) Detector, Refractive Index Detector (RID), Charged Aerosol Detector (CAD).

The present invention is by no means limited to the above-described preferred embodiments thereof. The rights sought are defined by the following claims within the scope of which many modifications can be envisaged.

1. A measuring system for measuring an ion concentration in a process liquid using capillary electrophoresis, comprising:
a feeding line extending between a first and second end, wherein the feeding line has a flow direction from the first to the second end;
an inlet that is connected to the feeding line at the first end;
a pump provided in the feeding line;
an expansion vessel that is connected to the feeding line with an expansion line, wherein the expansion line is provided with a first valve; and
a capillary electrophoresis measuring device that is connected to the feeding line at the second end,
wherein the pump, the first valve and the expansion vessel cooperate to build up and release pressure for loading samples in the capillary electrophoresis measuring device.

2. The measuring system according to claim 1, wherein the feeding line comprising a second valve positioned between the pump and the second end of the feeding line.

3. The measuring system according to claim 1 or 2, wherein the capillary electrophoresis measuring device comprises a first and second capillary, the first being an anion capillary and the second being a cation capillary.

4. The measuring system according to claim 3, wherein the capillary electrophoresis measuring device is connected to a three-way valve that connects the second end of the feeding line with the first capillary and the second capillary, the first and second capillary both preferably being in contact with an associated buffer solution container.

5. The measuring system according to claim 4, wherein the three-way valve and the first and second capillary are connected with a respective T-piece.

6. The measuring system according to claim 1, further comprising a waste container that is operatively connected to the expansion vessel, the feeding line and/or the capillary electrophoresis measuring device.

7. The measuring system according to claim 6, wherein each of the expansion vessel, the feeding line and the capillary electrophoresis measuring device are operatively connected to the waste container with a respective line, each line being provided with a valve.

8. The measuring system according to claim 1, further comprising a pressure sensor that is connected to the expansion vessel.

9. The measuring system according to claim 1, wherein the capillary electrophoresis measuring device comprises voltage circuit that is provided over a capillary; and/or
wherein the capillary electrophoresis measuring device comprises a contactless conductivity detector; and/or
wherein the inlet comprises a multivalve.

10-11. (canceled)

12. The measuring system according to claim 11, wherein the multivalve is connected to a second buffer solution container and a sample solution inlet such that the buffer solution and the sample solution are feedable into the feeding line.

13. The measuring system according to claim 1, further comprising a loading module comprising a buffer solution and/or a sample solution that is operatively connected to the inlet.

14. The measuring system according to claim 1, further comprising a dilution controller configured to dynamically dilute the sample solution, preferably diluting the sample solution with ultrapure water.

15. A water measuring system, comprising:
a measuring system according to claim 1; and
a water system that is operatively connected to the inlet for providing a sample solution.

16. A method for measuring an ion concentration in a process liquid using capillary electrophoresis, comprising:
filling a feeding line and a capillary electrophoresis measuring device with a buffer solution by using an expansion vessel;
filling the feeding line and the capillary electrophoresis measuring device with a sample solution by using the expansion vessel; and
applying a high voltage over the capillary to measure the sample solution with a detector of the capillary electrophoresis measuring device.

17. The method according to claim 16, wherein filling the feeding line and the capillary electrophoresis measuring device with the buffer solution comprises:
filling the feeding line with the buffer solution by providing the buffer solution through an inlet at a first end of the feeding line and opening a second valve positioned on the feeding line towards the capillary electrophoresis measuring device that is positioned at a second end of the feeding line;
building pressure on the buffer solution in the feeding line by running a pump positioned on the feeding line between the inlet and the second valve and opening a first valve to the expansion vessel and closing the second valve; and
releasing the pressurized buffer solution towards the capillary electrophoresis measuring device by opening the second valve in order to fill the capillary with the buffer solution.

18. The method according to claim 17, wherein filling the feeding line and the capillary electrophoresis measuring device with the sample solution comprises:
filling the feeding line with the sample solution by providing the sample solution through the inlet and opening the second valve;
building pressure on the sample solution in the feeding line by running the pump and opening the first valve to the expansion vessel and closing the second valve; and
loading the sample solution in the capillary by releasing the pressurized sample solution towards the capillary electrophoresis measuring device by opening the second valve.

19. The method according to claim 18, further comprising:
diluting the sample solution before being filling the feeding line with sample solution, wherein preferably the sample solution is dynamically diluted based on preceding measurements of the sample solution.

20. The method according to claim 17, further comprising:
releasing the pressure in the system after filing the capillary electrophoresis measuring device with the sample solution by opening a third valve positioned between the expansion vessel and a waste container and fourth valve positioned between the feeding line and the waste container and closing the second valve.

21. The method according to claim 20, further comprising closing the third valve, the fourth valve and a fifth valve positioned between the capillary electrophoresis measuring device and the waste container during the step of building and releasing pressure on the buffer solution and during the step of building and releasing pressure on the sample solution.

22. The method according to claim 16, wherein the step of filling the feeding line and the capillary electrophoresis measuring device with a sample solution is repeated before applying a high voltage over the capillary to measure the sample solution such that multiple sample solution units are loaded on the capillary electrophoresis measuring device; and/or
wherein the method further comprises filling the feeding line with the buffer solution by providing buffer solution through the inlet after loading the buffer solution in the capillary.

23. (canceled)
